(19) United States
(12) Patent Application Publication
(10) Pub. No.: US 2019/0203763 A1
(43) Pub. Date: Jul. 4, 2019

(54) ROLLER BEARING APPARATUS

(71) Applicant: NTN CORPORATION, Osaka (JP)

(72) Inventor: Masanori UENO, Mie (JP)

(21) Appl. No.: 16/311,724

(22) PCT Filed: May 24, 2017
(86) PCT No.: PCT/JP2017/019424

§ 371 Date: Dec. 20, 2018

(30) Foreign Application Priority Data
Jun. 21, 2016 (JP) 2016-122521

(51) Int. Cl. F16C 19/38; F16C 33/78; F16C 33/58

(52) U.S. Cl. CPC F16C 19/385; F16C 2326/10; F16C 33/583; F16C 33/7823

(57) ABSTRACT

A rolling bearing device includes a sealing member configured to seal a bearing internal space, and a sealing case configured to support a proximal end side of the sealing member. The sealing member includes a cored bar arranged so as to be opposed to the sealing case, and a lip portion configured to cover a distal end portion of the cored bar. The lip portion includes a pair of lips, and a first space isolated from other portions is formed between the pair of lips. The sealing member has an opening portion that is opened to the first space, and the opening portion is allowed to communicate with an atmospheric space through a first ventilation path formed through the sealing member and a second ventilation path formed in an opposing region between the cored bar and the sealing case.

### TECHNICAL FIELD

The present invention relates to a rolling bearing device comprising a sealing member.

### BACKGROUND ART

There has been known a rolling bearing device to be used for supporting an axle of a railway vehicle as disclosed in, for example, Patent Literature 1, and a bearing device of this type is exemplified in FIG. 8.

This bearing device includes a bearing 100 and sealing devices 150. The bearing 100 is a double-row tapered roller bearing being one type of rolling bearings, and includes an outer ring 110, inner rings 120, and tapered rollers 130. The outer ring 110 has raceway surfaces on an inner periphery thereof. The inner rings 120 each have a raceway surface on an outer periphery thereof. The tapered rollers 130 are rolling elements. The tapered rollers 130 are arranged in double rows between the raceway surfaces of the outer ring 110 and the raceway surfaces of the inner rings 120.

The sealing devices 150 include sealing cases 152, sealing members 154, an oil thrower 161, and a back cover 162. The sealing cases 152 are fitted and fixed to both end portions of an inner peripheral surface of the outer ring 110 in an axial direction. The sealing members 154 are fixed to inner peripheries of the sealing cases 152. The oil thrower 161 and the back cover 162 are arranged on both sides of the inner rings 120 in the axial direction. Each of the sealing members 154 forms contact seal between the oil thrower 161 or the back cover 162 and the sealing member 154. With this configuration, the sealing devices 150 are configured to seal, on both sides in the axial direction, a space between the outer ring 110 and the inner rings 120 (bearing internal space).

Specifically, as illustrated in FIG. 9, the sealing member 154 includes a main lip 157a, a dust lip 157b, and a cored bar 156. Those lips 157a and 157b are provided to the cored bar 156. The lips 157a and 157b are held in contact with the back cover 162 at two positions separated away from each other in the axial direction. With this, leakage of lubricant such as grease from the bearing internal space and entry of, for example, dust and water into the internal space are prevented.

A shape, stiffness, and the like of a seal lip such as the main lip 157a or the dust lip 157b are set in accordance with a usage and a use condition so as to exhibit a proper tension force. However, during rotation of an axle, due to increase in temperature of the bearing, a pressure in the bearing internal space (bearing internal pressure) sealed by the sealing member 154 is increased. Further, due to an action of attracting the main lip 157a through rotation of the oil thrower 161 or the back cover 162, a pressure in a space S between the main lip 157a and the dust lip 157b is reduced so that the space S is brought into a negative pressure state. When the bearing internal pressure is increased, or an inter-lip space S has a negative pressure, the main lip 157a is pressed against a sliding surface to increase a tension force. As a result, torque is increased, and heat generation is promoted. In addition, the seal lips cannot maintain a proper contact state with respect to the sliding surface due to deformation of the seal lips. Thus, wear of distal ends of the seal lips is promoted, with the result that sealing performance may be degraded.

As an invention for avoiding increase in tension forces of the seal lips due to increase in bearing internal pressure, there is given, for example, the invention disclosed in Patent Literature 2. The invention relates to a sealing device for a bearing device, which includes an internal pressure adjusting mechanism (vent) and an inside-air flowing mechanism. The internal pressure adjusting mechanism (vent) is configured to discharge inside air to an outside of the bearing device when an internal pressure in the bearing device is increased. The inside-air flowing mechanism is configured to allow inside air to flow from a bearing arrangement space to a seal arrangement space. The invention has a feature in that a cutout or a through hole configured to radially expand a part of an inner peripheral portion of a partition plate is formed as the inside-air flowing mechanism so that, even when the inside-air flowing mechanism is closed by a grease film, the grease film can be opened due to a pressure difference.

### CITATION LIST

Patent Literature 1: JP 2007-255599 A
Patent Literature 2: JP 4811194 B2

### SUMMARY OF INVENTION

### Technical Problem

However, in the configuration of Patent Literature 2, it is required to additionally provide the internal pressure adjusting mechanism (vent), thereby increasing cost. Further, the tension forces of the seal lips are also changed due to a cause other than fluctuation of the bearing internal pressure. For example, the space (inter-lip space S) surrounded by the main lip 157a, the dust lip 157b, and the back cover 162 (or oil thrower 161) is increased in temperature during rotation of an axle, and hence the pressure in the inter-lip space S is increased. When the pressure in the inter-lip space S exceeds a limit value, a distal end of the dust lip 157b is away from the back cover 162 (or oil thrower 161) so that air in the inter-lip space S is released to atmospheric air, and, due to elastic deformation of the dust lip 157b thereafter, the inter-lip space S returns to an original sealed stated. When the rotation of the axle is stopped in this state, the pressure in the inter-lip space S is reduced along with reduction in temperature so that the inter-lip space S is brought into the negative pressure state, and the main lip 157a and the dust lip 157b are attracted to the surface of the back cover 162 (or oil thrower 161), thereby increasing the tension forces of the seal lips. Further, due to the action of attracting the main lip 157a through rotation of the back cover 162 (or oil thrower 161), the pressure in the inter-lip space S is reduced so that the inter-lip space S is brought into the negative pressure state, thereby increasing the tension forces of the seal lips. When the axle is rotated again from this state, wear of the lips 157a and 157b is progressed. The configuration of Patent Literature 2 cannot deal with increase in tension forces caused when the seal lips are attracted as described above.

The present invention has been made in view of the above-mentioned circumstances, and has an object to prevent, for example, torque loss, increase in temperature, and abnormal wear of seal lips due to increase in tension forces of the seal lips.

### Solution to Problem

In order to solve the above-mentioned problem, according to one embodiment of the present invention, there is provided a rolling bearing device, comprising: an outer ring having a raceway surface on an inner periphery thereof; an inner ring having a raceway surface on an outer periphery thereof; a rolling element arranged between the raceway surface of the outer ring and the raceway surface of the inner ring; a sealing member configured to seal a bearing internal space between the outer ring and the inner ring; and a supporting member configured to support a proximal end side of the sealing member, the sealing member comprising a cored bar arranged so as to be opposed to the supporting member, and a lip portion configured to cover at least a distal end portion of the cored bar, the lip portion comprising a pair of lips that forms an inter-lip space isolated from other portions between the pair of lips, wherein the sealing member has an opening portion that is opened to the inter-lip space, and wherein the opening portion is allowed to communicate with an atmospheric space through a first ventilation path formed through the sealing member and a second ventilation path formed in an opposing region between the cored bar and the supporting member.

According to the configuration described above, the inter-lip space communicates to the atmospheric space through the first ventilation path and the second ventilation path. Therefore, the inter-lip space has an atmospheric pressure, thereby being capable of avoiding such a situation that a negative pressure is generated in the inter-lip space. Accordingly, the pair of lips can be prevented from being attracted to a sliding contact member due to the negative pressure generated in the inter-lip space, thereby being capable of preventing increase in tension forces of the pair of lips.

In the above-mentioned configuration, the first ventilation path may be formed between the cored bar and the lip portion.

According to this configuration, the first ventilation path can be formed easily. In this configuration, the first ventilation path may be formed of a recessed portion formed in the cored bar.

In the above-mentioned configuration, the second ventilation path may be formed of a recessed portion formed in the cored bar. Further, the second ventilation path may be formed of a recessed portion formed in the supporting member.

In the above-mentioned configuration, the inter-lip space may be isolated from other portions by a sliding contact member that is held in slide contact with the pair of lips, and the sliding contact member may have a third ventilation path configured to allow communication between the bearing internal space and the atmospheric space.

According to this configuration, increase in pressure in the bearing internal space due to increase in temperature through an operation of the bearing can be prevented. With this, the lip on the bearing inner side can be prevented from being pressed against a sliding surface, thereby being capable of preventing increase in tension force of the lip on the bearing inner side. Further, in this configuration, when a differential pressure regulating valve, which is configured to close in normal time and open during generation of a differential pressure, is provided in the third ventilation path, the differential pressure regulating valve closes in normal time, thereby being capable of preventing entry of, for example, dust and water into the bearing.

The bearing device described above is preferably used for an axle of a railway vehicle.

### Advantageous Effects of Invention

According to the present invention, it is possible to avoid problems such as increase in torque loss, heat generation, and abnormal wear of the seal lips due to increase in tension forces of the seal lips.

### BRIEF DESCRIPTION OF DRAWINGS

FIG. 1 is a sectional view of a rolling bearing device according to an embodiment of the present invention, which is taken along an axial direction.

FIG. 2 is an enlarged view of the part B in FIG. 1.

FIG. 3 is an enlarged view of the part C in FIG. 2.

FIG. 4 is an enlarged sectional view of a main part of a rolling bearing device according to a modification example of the present invention, which is taken along an axial direction.

FIG. 5 is an enlarged sectional view of a main part of a rolling bearing device according to a modification example of the present invention, which is taken along an axial direction.

FIG. 6 is a sectional view of a rolling bearing device according to a reference example of the present invention, which is taken along an axial direction.

FIG. 7 is a sectional view of a rolling bearing device according to a reference example of the present invention, which is taken along an axial direction.

FIG. 8 is a sectional view of a related-art rolling bearing device, which is taken along an axial direction.

FIG. 9 is an enlarged view of the part A in FIG. 8.

### DESCRIPTION OF EMBODIMENTS

Now, an embodiment of the present invention is described with reference to the drawings.

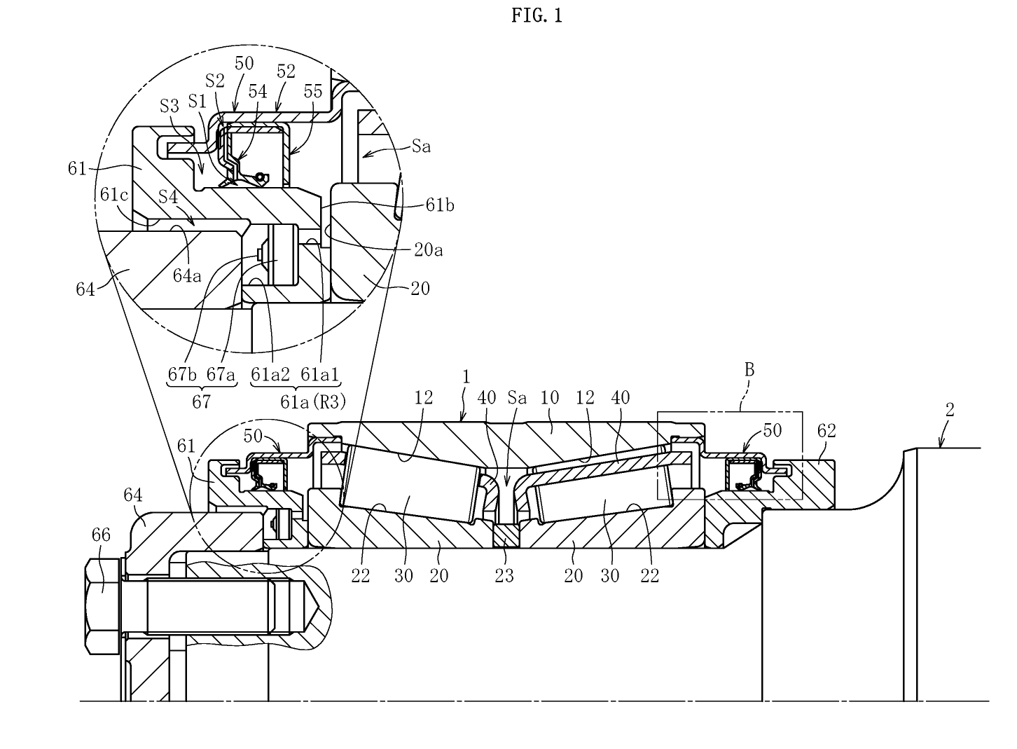

In FIG. 1, a rolling bearing device according to the embodiment of the present invention is illustrated. This bearing device is to be used for supporting an axle of a railway vehicle, and comprises a bearing 1 and sealing devices 50. The bearing 1 is a double-row tapered roller bearing being one type of rolling bearings, and comprises an outer ring 10, two inner rings 20, a plurality of tapered rollers 30 being rolling elements, and a cage 40.

The outer ring 10 has tapered raceway surfaces 12 arranged in double rows on an inner periphery thereof, and the inner rings 20 each have a tapered raceway surface 22 on an outer periphery thereof. The two inner rings 20 are arranged so that small-diameter-side end portions thereof are opposed to each other through intermediation of a spacer 23. With this, the double-row raceway surfaces 22 are formed. The two inner rings 20 may be arranged so that the small-diameter-side end portions are directly held in abutment against each other. The tapered rollers 30 arranged in double rows are interposed between the raceway surfaces 12 of the outer ring 10 and the raceway surfaces 22 of the inner rings 20. The cage 40 is configured to retain the tapered rollers 30 in each row at equal intervals in a circumferential direction. Lubricant such as grease is filled in a space (bearing internal space Sa) formed between the outer ring 10 and the inner rings 20, and the sealing devices 50 seal the space on both end portions in an axial direction.

The outer ring 10 is fixed to a journal box (not shown) of a railway vehicle in such a manner that an outer peripheral surface of the outer ring 10 is fitted to an inner peripheral surface of the journal box so as to fix, in the axial direction, an end surface of the outer ring 10 in the axial direction. An oil thrower 61 and aback cover 62 being sliding contact members are arranged on bearing outer sides of the two inner rings 20, respectively. A cover member 64 is fixed to an axial end of an axle 2 with a bolt 66, and the oil thrower 61, the inner rings 20, and the back cover 62 fitted to the outer periphery of the axle 2 are fixed by being sandwiched between the cover member 64 and a shoulder portion of the axle 2.

Next, a configuration of the sealing device 50 on the right side in FIG. 1 is described. The sealing device 50 on the left side in FIG. 1 has the same configuration except that the oil thrower 61 is employed instead of the back cover 62.

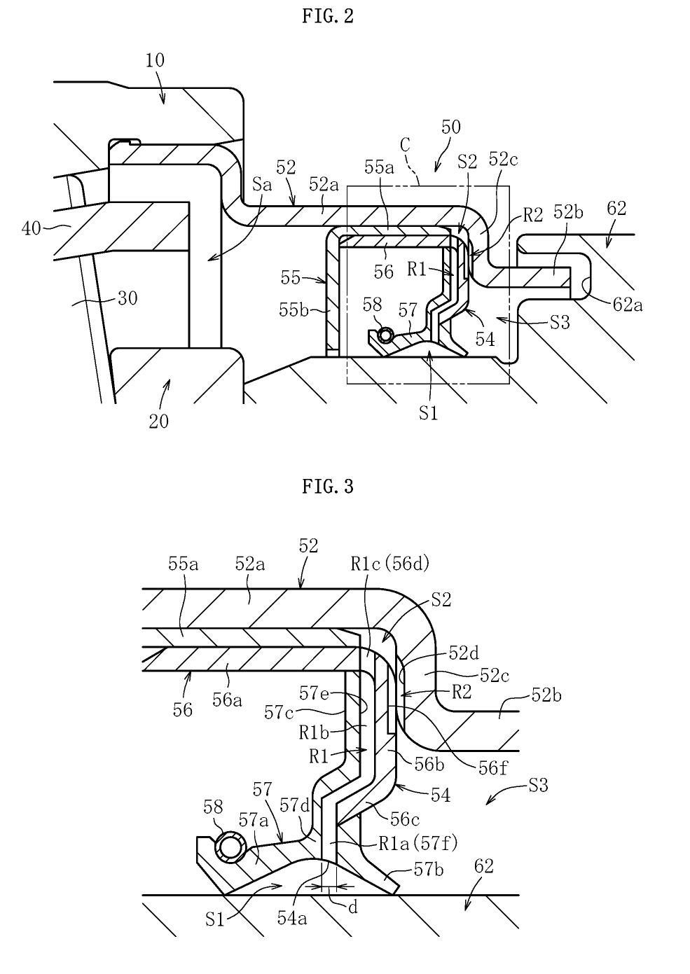

As illustrated in FIG. 2 in an enlarged manner, the sealing device 50 comprises a sealing case 52, a sealing member 54, a partition plate 55, and the back cover 62. The sealing case 52 has a stepped cylindrical shape. The partition plate 55 has an L shape in cross section. The sealing case 52 functions as a supporting member configured to support a proximal end side of the sealing member 54. One end portion of the sealing case 52 in the axial direction (end portion on a bearing inner side) is press-fitted and fixed to an inner periphery of an opening portion at each end of the outer ring 10 in the axial direction. Another end portion of the sealing case 52 in the axial direction (end portion on the bearing outer side) is inserted into a recessed portion 62a formed in an end surface of the back cover 62. In this manner, non-contact seal is formed. Further, the sealing member 54 forms contact seal between the sealing member 54 and the back cover 62. With this configuration, the sealing device 50 seals the bearing internal space Sa by the contact seal.

The sealing case 52 comprises a large diameter portion 52a, a small diameter portion 52b, and a connecting portion 52c. The large diameter portion 52a has a cylindrical shape. The small diameter portion 52b has a cylindrical shape. The connecting portion 52c has a flat-plate-like shape, and extends in a radial direction so as to be continuous with the large diameter portion 52a and the small diameter portion 52b. The partition plate 55 is press-fitted and fixed to an inner peripheral side of the large diameter portion 52a of the sealing case 52, and comprises a fixing portion 55a and a partition portion 55b. The fixing portion 55a has a flat-plate-like shape, and one end portion of the fixing portion 55a in the axial direction is opposed to the connecting portion 52c of the sealing case 52 through a gap. The partition portion 55b has a flat-plate-like shape, and is formed on another end portion of the fixing portion 55a in the axial direction so as to extend to a radially inner side.

A radially inner end of the partition portion 55b of the partition plate 55 is arranged in proximity to an outer peripheral surface of the back cover 62 to form non-contact seal. The partition plate 55 prevents such a situation that lubricant such as grease filled in the bearing internal space Sa of the bearing 1 directly flows to the sealing member 54.

The sealing member 54 is press-fitted and fixed to an inner periphery of the partition plate 55. The sealing member 54 is so-called oil seal, and comprises a cored bar 56, a lip portion 57, and a garter spring 58. The lip portion 57 is made of an elastic material, and is fixed to the cored bar 56. The cored bar 56, the lip portion 57, and the garter spring 58 each have an annular shape.

As illustrated in FIG. 3 in an enlarged manner, the cored bar 56 is press-fitted and fixed to the inner periphery of the fixing portion 55a of the partition plate 55, and integrally comprises an abutment portion 56a, a radial portion 56b, and an inclined portion 56c. The abutment portion 56a has a cylindrical shape, and one end portion of the abutment portion 56a in the axial direction is held in abutment against the partition portion 55b of the partition plate 55. The radial portion 56b has a flat-plate-like shape, and is formed on another end portion of the abutment portion 56a in the axial direction. The radial portion 56b extends to the radially inner side, and is held in abutment against the connecting portion 52c of the sealing case 52. The inclined portion 56c has a conical shape inclined to the radially inner side from the radially inner end portion of the radial portion 56b toward the bearing inner side. A partial region of the radial portion 56b of the cored bar 56 is arranged so as to be opposed to a partial region of the connecting portion 52c of the sealing case 52.

The lip portion 57 covers at least a distal end portion of the cored bar 56 on the radially inner side. Further, a pair of lips (main lip 57a and dust lip 57b) held in contact with the back cover 62 are formed on the lip portion 57. Specifically, the lip portion 57 comprises a covering portion 57c, a base portion 57d, the main lip 57a, and the dust lip 57b. The covering portion 57c is fixed to the cored bar 56, and covers a bearing inner side of the cored bar 56. The base portion 57d is fixed to the cored bar 56, and is continuous with the covering portion 57c. The main lip 57a extends from the base portion 57d toward the bearing inner side. The dust lip 57b extends from the base portion 57d toward the bearing outer side.

The lip portion 57 is made of, for example, a rubber material such as nitrile rubber, acrylic rubber, or fluoro rubber. The lip portion 57 is fixed to the cored bar 56 by means of, for example, vulcanization bonding. The lip portion 57 may also be made of resin.

Both the lips 57a and 57b are held in contact with the outer peripheral surface (sliding surface) of the back cover 62 with an interference. The garter spring 58 is mounted to the outer periphery of the main lip 57a. With the interference and an elastic force in a direction of the radial contraction of the garter spring 58, a tension force having a predetermined magnitude is applied to a distal end portion of the main lip 57a.

A first space S1 (inter-lip space) isolated from other portions is formed between both the lips 57a and 57b. Specifically, the first space S1 is formed by both the lips 57a and 57b, the base portion 57d, and the outer peripheral surface of the back cover 62. Further, a second space S2 isolated from other portions is formed by the large diameter portion 52a and the connecting portion 52c of the sealing case 52, the fixing portion 55a of the partition plate 55, and the abutment portion 56a and the radial portion 56b of the cored bar 56. Further, a third space S3 partitioned from other portions is formed by the back cover 62, the sealing member 54, and the small diameter portion 52b of the sealing case 52. The third space S3 is continuous with an atmospheric space through a gap between a distal end portion of the sealing case 52 and the recessed portion 62a of the back cover 62.

An opening portion 54a that is opened to the first space S1 is formed in the sealing member 54. The opening portion 54a communicates to the atmospheric space through a first ventilation path R1, a second ventilation path R2, and the third space S3. The first ventilation path R1 is formed through the sealing member 54. The second ventilation path R2 is formed in an opposing region between the cored bar 56 and the sealing case 52. The first ventilation path R1 allows communication between the first space S1 and the second space S2, and the second ventilation path R2 allows communication between the second space S2 and the third space S3. Further, the second ventilation path R2 is provided between the connecting portion 52c of the sealing case 52 and the radial portion 56b of the cored bar 56.

The first ventilation path R1 may be provided at one position in the circumferential direction, or first ventilation paths R1 may be provided at a plurality of positions in the circumferential direction. This similarly applies to the second ventilation path R2. Further, the number of the first ventilation paths R1 and the number of the second ventilation paths R2 may be the same or different from each other. The first ventilation path R1 and the second ventilation path R2 may be located at the same position in the circumferential direction or at different positions in the circumferential direction.

The first ventilation path R1 comprises a first portion R1a, a second portion R1b, and a third portion R1c. The first portion R1a is formed of a through hole 57f formed in the base portion 57d. The second portion R1b is provided between a recessed portion 57e formed in the covering portion 57c of the lip portion 57 and a flat portion in the radial portion 56b and the inclined portion 56c of the cored bar 56. The third portion R1c is formed of a through hole 56d extending in the radial direction and being formed in the abutment portion 56a of the cored bar 56.

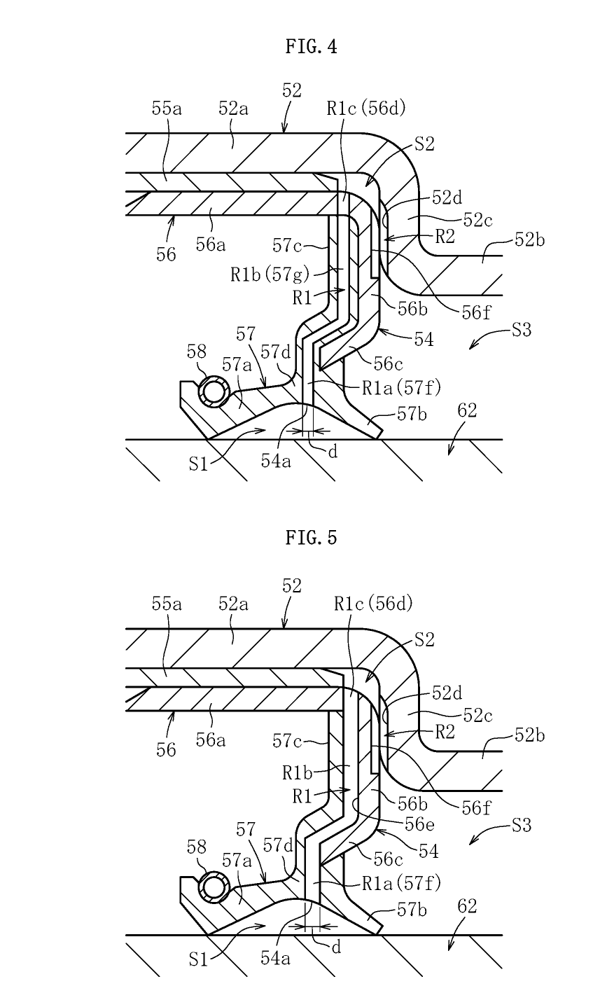

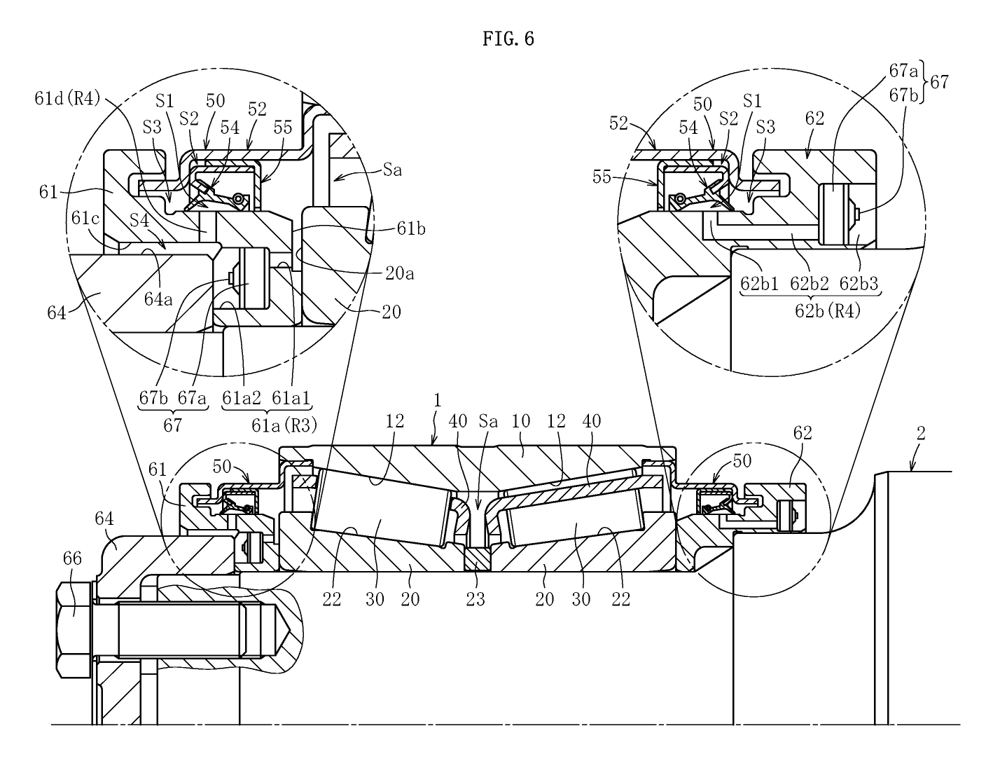

As illustrated in FIG. 4, the second portion R1b may be formed of a through hole 57g formed in the covering portion 57c. Further, as illustrated in FIG. 5, the second portion R1b may be provided between a first recessed portion 56e formed on the bearing inner side in the radial portion 56b and the inclined portion 56c of the cored bar 56 and a flat portion of the covering portion 57c. Further, although not illustrated, the second portion R1b may be provided between the first recessed portion 56e of the cored bar 56 and the recessed portion 57e of the covering portion 57c.

As illustrated in FIG. 3, the second ventilation path R2 is provided between a second recessed portion 56f and a third recessed portion 52d. The second recessed portion 56f is formed on the bearing outer side in the radial portion 56b of the cored bar 56. The third recessed portion 52d is formed on the bearing inner side in the connecting portion 52c of the sealing case 52.

As a matter of course, the second ventilation path R2 may be provided between the second recessed portion 56f of the cored bar 56 and a flat portion in the connecting portion 52c of the sealing case 52, or may be provided between a flat portion in the radial portion 56b of the cored bar 56 and the third recessed portion 52d of the sealing case 52.

As illustrated on the left side in FIG. 1, in the rolling bearing device, there is provided a third ventilation path R3 configured to allow communication between the bearing internal space Sa and the atmospheric space. The third ventilation path R3 may be provided at one position in the circumferential direction, or third ventilation paths R3 may be provided at a plurality of positions in the circumferential direction.

The third ventilation path R3 is formed of a through hole 61a extending in the axial direction and being formed in the oil thrower 61. The through hole 61a is a stepped hole comprising a small diameter portion 61a1 and a large diameter portion 61a2. One end of the through hole 61a (end portion on the small diameter portion 61a1 side) is opened to the gap between an end surface 61b of the oil thrower 61 and an end surface 20a of the inner ring 20. This gap is continuous with the bearing internal space Sa. Another end of the through hole 61a (end portion on the large diameter portion 61a2 side) is opened to a fourth space S4 between an inner peripheral surface 61c of the oil thrower 61 and an outer peripheral surface 64a of the cover member 64. The fourth space S4 is continuous with the atmospheric space.

A differential pressure regulating valve (vent 67), which is configured to close in normal time and open during generation of a differential pressure, is arranged in the large diameter portion 61a2. The vent 67 is made of an elastic material such as rubber, and comprises a cylindrical portion 67a and a valve portion 67b. The cylindrical portion 67a is fitted and fixed to an inner periphery of the large diameter portion 61a2. The valve portion 67b protrudes from the cylindrical portion 67a to the fourth space S4 side. A cutout (not shown) is formed in the top of the valve portion 67b. When a differential pressure that is equal to or higher than a certain level is generated between the bearing internal space Sa and the fourth space S4, the cutout is opened due to elastic deformation of the valve portion 67b to allow communication between the bearing internal space Sa and the fourth space S4. Meanwhile, under a state in which a differential pressure is not generated or is low, the cutout is closed due to elastic return of the valve portion 67b to isolate the bearing internal space Sa and the fourth space S4 from each other.

Thus, when a pressure in the bearing internal space Sa is increased along with an operation of the bearing, the vent 67 is opened to release the bearing internal space Sa to the atmospheric space. Therefore, the bearing internal space Sa can be kept at a pressure substantially equal to an atmospheric pressure irrespective of the state of the operation of the bearing. Further, when the differential pressure between the bearing internal space Sa and the fourth space S4 is low, the vent 67 is closed. Accordingly, leakage of lubricant from the bearing internal space Sa and entry of, for example, dust and water into the bearing internal space Sa can be prevented.

With the configuration described above, the first space S1 communicates with the atmospheric space through the first ventilation path R1, the second space S2, the second ventilation path R2, and the third space S3. Therefore, the first space S1 has the atmospheric pressure, thereby being capable of avoiding such a situation that a negative pressure is generated in the first space S1. Accordingly, the main lip 57a and the dust lip 57b can be prevented from being attracted to the back cover 62 (or oil thrower 61) due to the negative pressure generated in the first space S1, thereby being capable of preventing increase in tension forces of the main lip 57a and the dust lip 57b. Thus, in the rolling bearing device according to the embodiment, it is possible to avoid problems such as increase in torque loss, heat generation, and abnormal wear of the lips due to the increase in tension forces of the main lip 57a and the dust lip 57b.

Further, the third space S3 is on an inner peripheral side of the small diameter portion 52b of the sealing case 52. Thus, with the small diameter portion 52b, entry of, for example, dust and water into the third space S3 from the outside can be prevented. Moreover, the first ventilation path R1, the second space S2, and the second ventilation path R2 forms a path that is bent at the second space S2. Thus, entry of, for example, dust and water into the first space S1 from the third space S3 can be prevented. Therefore, entry of, for example, dust and water into the first space S1 from the outside can be prevented.

The first portion R1a of the first ventilation path R1 on the first space S1 side extends straight along the radial direction, and has a circular shape in transverse cross section. Therefore, the opening portion 54a of the first ventilation path R1 with respect to the first space S1 has a circular shape as viewed along the radial direction, and a diameter of this circular shape is represented by “d”.

In order to avoid closing of the first ventilation path R1 by lubricant such as grease in the first space S1, it is preferred that the diameter “d” be large. Specifically, the diameter “d” is preferably 1.5 mm or more, more preferably 2.0 mm or more, most preferably 2.5 mm or more. Meanwhile, in order to prevent leakage of lubricant such as grease in the first space S1 through the first ventilation path R1, a diameter of the opening portion 54a of the first ventilation path R1 with respect to the first space is preferably 5.5 mm or less, more preferably 5.0 mm or less, most preferably 4.5 mm or less.

In the above description, there is exemplified the configuration in which the first ventilation path R1 and the second ventilation path R2 are provided in the rolling bearing device. Even in a rolling bearing device having the following configuration, such a situation that a negative pressure is generated in the first space S1 can be avoided.

In the sealing device 50 illustrated on the left side in FIG. 6, a fourth ventilation path R4 configured to allow communication between the first space S1 and the atmospheric space is provided in the oil thrower 61. The fourth ventilation path R4 is formed of a through hole 61d extending straight in the radial direction and being formed in the oil thrower 61. A radially outer end of the through hole 61d is opened to the first space S1, and a radially inner end of the through hole 61d is opened to the fourth space S4. The fourth space S4 is continuous with the atmospheric space, and hence the first space S1 has the atmospheric pressure through the fourth ventilation path R4. With this, such a situation that a negative pressure is generated in the first space S1 can be avoided.

In the sealing device 50 illustrated on the right side in FIG. 6, a through hole 62b formed in the back cover 62 forms the fourth ventilation path R4. The through hole 62b comprises a small-diameter radial portion 62b1, a small-diameter axial portion 62b2, and a large-diameter axial portion 62b3. One end of the through hole 62b (end portion on the small-diameter radial portion 62b1 side) is opened to the first space S1, and another end of the through hole 62b (end portion on the large-diameter axial portion 62b3 side) is opened to the atmospheric space. The vent 67 is arranged in the large-diameter axial portion 62b3. The vent 67 is configured to operate when the pressure in the first space S1 becomes lower than the atmospheric pressure so that the first space S1 has a pressure substantially equal to the atmospheric pressure. With this, such a situation that a negative pressure is generated in the first space S1 can be avoided.

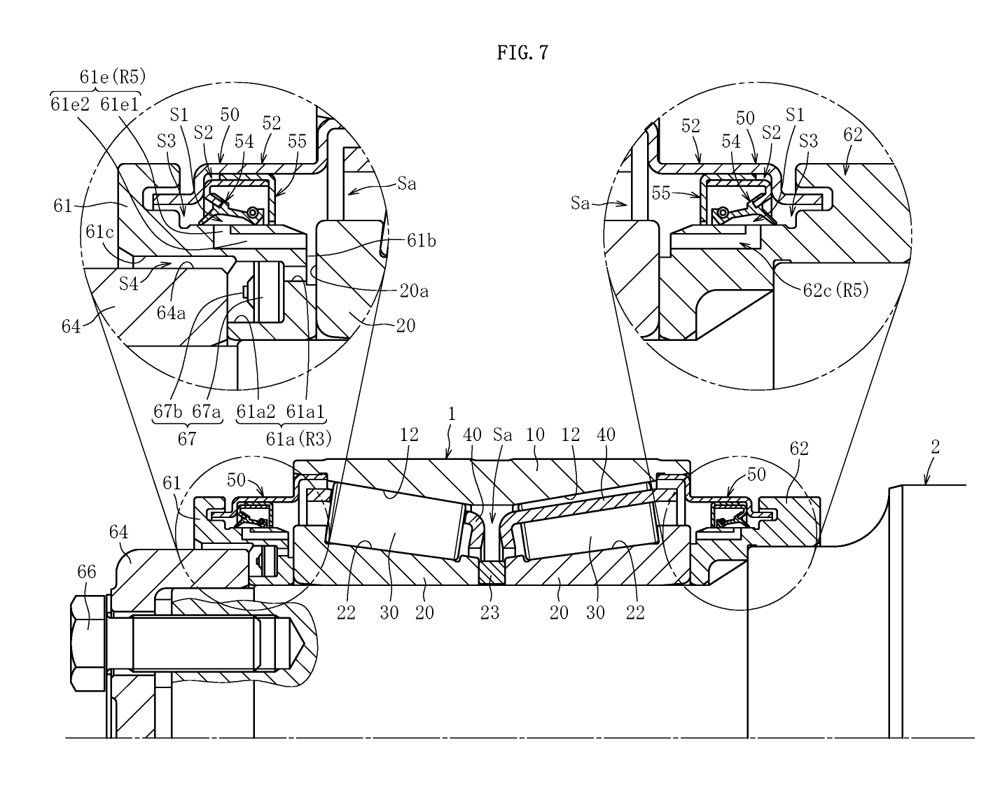

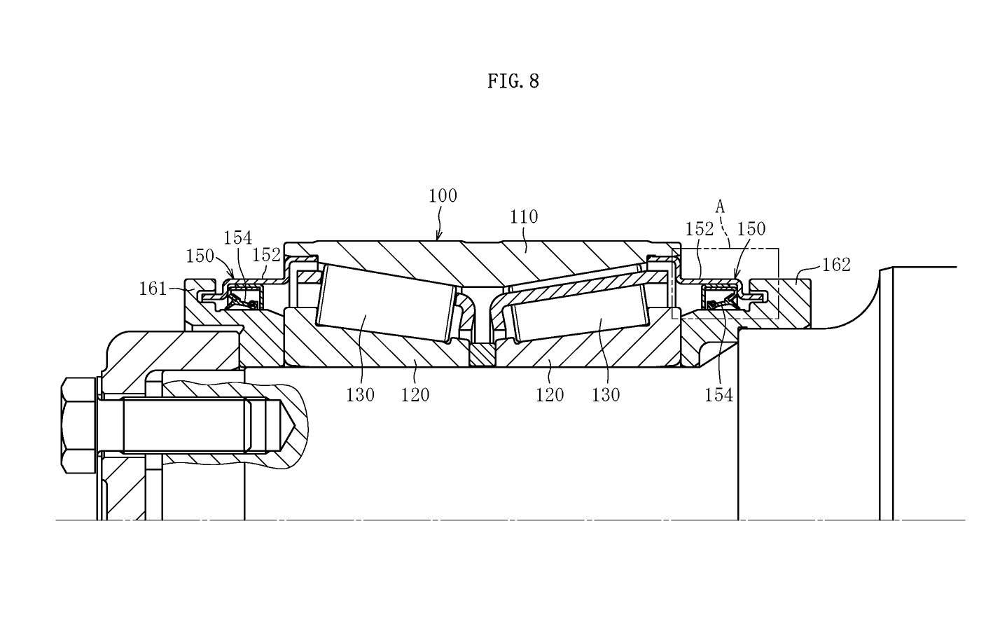

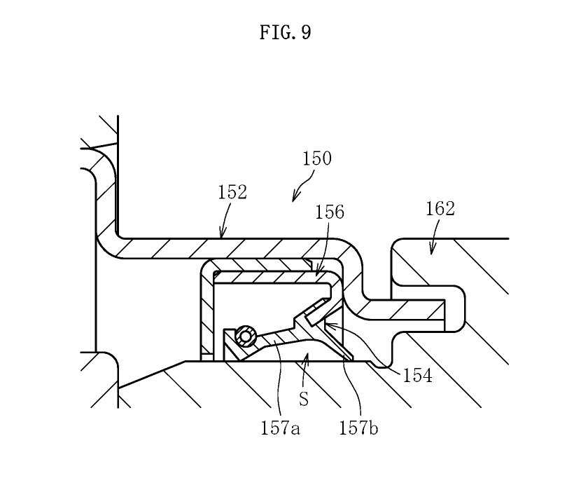

In the sealing device 50 illustrated on the left side in FIG. 7, a fifth ventilation path R5 configured to allow communication between the first space S1 and the bearing internal space Sa is provided in the oil thrower 61. In the illustrated example, a through hole 61e formed in the oil thrower 61 forms the fifth ventilation path R5. The through hole 61e comprises a radial portion 61e1 and an axial portion 61e2. One end of the through hole 61e (end portion on the radial portion 61e1 side) is opened to the first space S1, and another end of the through hole 61e (end portion on the axial portion 61e2 side) is opened to the gap between the end surface 61b of the oil thrower 61 and the end surface 20a of the inner ring 20. This gap is continuous with the bearing internal space Sa.

Also in the sealing device 50 illustrated on the right side in FIG. 7, there is provided a fifth ventilation path R5 having the same configuration as that of the fifth ventilation path R5 of the sealing device 50 illustrated on the left side. The fifth ventilation path R5 of the sealing device 50 illustrated on the right side is formed of a through hole 62c formed in the back cover 62.

The fifth ventilation path R5 illustrated in FIG. 7 allows communication between the first space S1 and the bearing internal space Sa. Thus, the first space S1 has a pressure equal to that in the bearing internal space Sa. The bearing internal space Sa is kept at a pressure substantially equal to the atmospheric pressure through the third ventilation path R3 in which the vent 67 is arranged, thereby being capable of avoiding such a situation that a negative pressure is generated in the first space S1.

In each of the fourth ventilation path R4 and the fifth ventilation path R5, it is preferred that a position of the opening portion, which is opened to the first space S1, in the oil thrower 61 or the back cover 62 be set to a position at which the opening portion is not overlapped with the main lip 57a or the dust lip 57b in consideration of relative movement of the oil thrower 61 or the back cover 62 and the sealing member 54 during use of the bearing. This is for the purpose of preventing wear or the like of the main lip 57a or the dust lip 57b from being caused by contact between the main lip 57a or the dust lip 57b and an edge of the opening portion of the fourth ventilation path R4 or the fifth ventilation path R5.

Further, in each of the fourth ventilation path R4 and the fifth ventilation path R5, the opening portion that is opened to the first space S1 also has a circular shape as viewed along the radial direction, and a preferable numerical range of a diameter of the circular shape and a reason thereof are the same as those of the diameter “d” described above. Further, each of the fourth ventilation path R4 and the fifth ventilation path R5 may be provided at one position in the circumferential direction, or both of fourth ventilation paths R4 and fifth ventilation paths R5 may be provided at a plurality of positions in the circumferential direction.

The present invention is not limited to the above-mentioned embodiment, and various modifications may be made thereto within the scope of the technical concept. For example, the sliding contact member that is held in slide contact with the main lip 57a and the dust lip 57b may not be the oil thrower 61 or the back cover 62, and, for example, may be the inner ring 20.

### REFERENCE SIGNS LIST

1 bearing
10 outer ring
12 raceway surface
20 inner ring
22 raceway surface
52 sealing case (supporting member)
52a large diameter portion
52b small diameter portion
52c connecting portion
52d third recessed portion
54 sealing member
54a opening portion
55 partition plate
55a fixing portion
55b partition portion
56 cored bar
56a abutment portion
56b radial portion
56e first recessed portion
56f second recessed portion
57 lip portion
57a main lip
57b dust lip
57c covering portion
61 oil thrower (sliding contact member)
62 back cover (sliding contact member)
67 vent (differential pressure regulating valve)
d diameter
R1 first ventilation path
R1b second portion
R2 second ventilation path
R3 third ventilation path
S1 first space (inter-lip space)
Sa bearing internal space

1. A rolling bearing device, comprising:
an outer ring having a raceway surface on an inner periphery thereof;
an inner ring having a raceway surface on an outer periphery thereof;
a rolling element arranged between the raceway surface of the outer ring and the raceway surface of the inner ring;
a sealing member configured to seal a bearing internal space between the outer ring and the inner ring; and
a supporting member configured to support a proximal end side of the sealing member,
the sealing member comprising a cored bar arranged so as to be opposed to the supporting member, and a lip portion configured to cover at least a distal end portion of the cored bar,
the lip portion comprising a pair of lips that forms an inter-lip space isolated from other portions between the pair of lips,
wherein the sealing member has an opening portion that is opened to the inter-lip space, and
wherein the opening portion is allowed to communicate with an atmospheric space through a first ventilation path formed through the sealing member and a second ventilation path formed in an opposing region between the cored bar and the supporting member.

2. The rolling bearing device according to claim 1, wherein the first ventilation path is formed between the cored bar and the lip portion.

3. The rolling bearing device according to claim 2, wherein the first ventilation path is formed of a recessed portion formed in the cored bar.

4. The rolling bearing device according to claim 1, wherein the second ventilation path is formed of a recessed portion formed in the cored bar.

5. The rolling bearing device according to claim 1, wherein the second ventilation path is formed of a recessed portion formed in the supporting member.

6. The rolling bearing device according to claim 1,
wherein the inter-lip space is isolated from other portions by a sliding contact member that is held in slide contact with the pair of lips, and
wherein the sliding contact member has a third ventilation path configured to allow communication between the bearing internal space and the atmospheric space.

7. The rolling bearing device according to claim 6, wherein a differential pressure regulating valve, which is configured to close in normal time and open during generation of a differential pressure, is provided in the third ventilation path.

8. The rolling bearing device according to claim 1, wherein the rolling bearing device is used for an axle of a railway vehicle.
